(19) United States
(12) Patent Application Publication
(10) Pub. No.: US 2021/0077328 A1
(43) Pub. Date: Mar. 18, 2021

(54) OVERHEAD SUBJECT LIFTS AND METHODS FOR OPERATING THE SAME

(71) Applicant: Liko Research & Development AB, Lulea (SE)

(72) Inventor: Jesse Newman, Rochester, NY (US)

(73) Assignee: Liko Research & Development AB, Luleå (SE)

(21) Appl. No.: 17/019,482

(22) Filed: Sep. 14, 2020

Related U.S. Application Data
(60) Provisional application No. 62/901,362, filed on Sep. 17, 2019.

(51) Int. Cl. A61G 7/10

(52) U.S. Cl. CPC A61G 7/1042; A61G 2203/10; A61G 7/1051; A61G 7/1015

(57) ABSTRACT

An overhead subject lift includes a lift assembly configured to be movably engaged with an overhead rail, the lift assembly including a coupler for coupling a subject to the lift assembly, an extendable member coupled to the coupler, an actuator for moving the coupler and the extendable member, and a sensor that detects a position of at least one of the extendable member and the coupler in at least one of a lateral direction and a longitudinal direction.

### CROSS-REFERENCE TO RELATED APPLICATIONS

This application claims the benefit of U.S. Provisional Patent Application Ser. No. 62/901,362 filed Sep. 17, 2019, the contents of which are hereby incorporated by reference in their entirety.

### FIELD

The present specification generally relates to overhead subject lifts and methods for operating the same. In particular, the present specification relates to overhead subject lifts including a lift assembly and methods for moving the lift assembly along an overhead rail.

### TECHNICAL BACKGROUND

Subject lifts, such as overhead subject lifts, are used to transport subjects for any number of reasons. Overhead subject lifts may be mounted to a ceiling and may include a motor and a lift drum that is driven by the motor. A lift strap may be coupled to the lift drum for lifting and lowering a subject when the drum is rotated. For example, as the lift drum rotates, the lift strap is either wound up onto the lift drum or paid out from the lift drum. A sling bar may be attached to the overhead subject lift to connect a subject to the overhead subject lift. For example, an accessory such as a sling, a vest, or the like, may be attached to a subject, and the accessory may be coupled to the sling bar to connect the subject to the overhead subject lift, such that the subject may be lifted or lowered as the lift strap is wound up onto the lift drum, or paid out from the lift drum.

Overhead subject lifts may generally be engaged with ceiling-mounted rails, and the overhead subject lifts may be movable along the rails so that subjects connected to the overhead subject lifts may be moved between different locations along the rails. Overhead subject lifts may be moved along the rails by an actuator, such as a motor or the like. The actuator may be controlled by a caregiver through a user input device communicatively coupled to the actuator. For example, a caregiver may utilize a hand-held user input device to move a conventional overhead lift assembly along an overhead rail. However, with at least one hand manipulating the user input device, it may be difficult for the caregiver to simultaneously control and manipulate the subject.

Accordingly, a need exists for alternative overhead subject lifts including features for controlling movement of a lift assembly along an overhead rail.

### SUMMARY

In a first aspect A1, an overhead subject lift includes an overhead rail extending at one of a longitudinal direction and a lateral direction, a lift assembly movably coupled to the overhead rail, the lift assembly including a coupler for coupling a subject to the lift assembly, an extendable member coupled to the coupler, a lift actuator engaged with the extendable member, where the lift actuator moves the extendable member and the coupler upward to, and downward from the lift actuator in a vertical direction that is transverse to the longitudinal direction and the lateral direction, a transverse actuator engaged with the overhead rail, and a transverse sensor that detects a position of at least one of the extendable member and the coupler, and a controller communicatively coupled to the lift actuator, the transverse actuator, and the transverse sensor, the controller including a processor and a computer readable and executable instruction set, which, when executed, causes the processor to receive a signal from the transverse sensor indicative of a detected position of at least one of the coupler and the extendable member in at least one of the longitudinal direction and the lateral direction, and direct the transverse actuator to move the lift assembly along the overhead rail toward the detected position of the at least one of the coupler and the extendable member.

In a second aspect A2, the present disclosure provides an overhead subject lift according to aspect A1, further including a user input communicatively coupled to the controller, where the computer readable and executable instruction set, when executed, further causes the processor to receive a signal from the user input indicative of a desired direction of operation of the lift actuator upward or downward in the vertical direction, and direct the lift actuator to move the extendable member in the desired direction of operation.

In a third aspect A3, the present disclosure provides an overhead subject lift according to either of aspects A1 or A2, where the signal from the transverse sensor is indicative of the detected position of the at least one of the coupler and the extendable member with respect to a centered position, and where the computer readable and executable instruction set, when executed, causes the processor to direct the transverse actuator to move the lift assembly at a speed that is proportional to a distance between the detected position of the at least one of the coupler and the extendable member with respect to the centered position.

In a fourth aspect A4, the present disclosure provides an overhead subject lift according to any of aspects A1-A3, where the overhead rail is a first overhead rail extending the longitudinal direction and where the overhead subject lift further includes a second overhead rail engaged with the first overhead rail extending in the lateral direction.

In a fifth aspect A5, the present disclosure provides an overhead subject lift according to any of aspects A1-A4, where the transverse actuator is a first transverse actuator, and the overhead subject lift further includes a second transverse actuator engaged with the second overhead rail and the first overhead rail.

In a sixth aspect A6, the present disclosure provides an overhead subject lift according to aspect A5, where the computer readable and executable instruction set, when executed, further causes the second transverse actuator to move the first overhead rail toward the detected position of the at least one of the coupler and the extendable member.

In a seventh aspect A7, the present disclosure provides an overhead subject lift according to aspect A5, where the signal from the transverse sensor is indicative of the detected position of the at least one of the coupler and the extendable member with respect to a centered position, and where the computer readable and executable instruction set, when executed, further causes the processor to direct the first transverse actuator to move the lift assembly along the first overhead rail at a speed that is proportional to a distance between the detected position of the at least one of the coupler and the extendable member with respect to the centered position, and direct the second transverse actuator to move the first overhead rail at a speed that is proportional to the distance between the detected position of the at least one of the coupler and the extendable member with respect to the centered position.

In an eighth aspect A8, the present disclosure provides an overhead subject lift according to any of aspects A1-A7, where the signal from the transverse sensor is indicative of the detected position of the at least one of the coupler and the extendable member with respect to a centered position, and where the computer readable and executable instruction set, when executed, further causes the processor to receive a signal from the transverse sensor indicating that the detected position of the at least one of the coupler and the extendable member is at the centered position, and direct the transverse actuator to cease moving the lift assembly.

In a ninth aspect A9, a method for operating an overhead subject lift includes detecting a position of at least one of a coupler and an extendable member of a lift assembly with a transverse sensor, where the lift assembly includes the coupler for coupling a subject to the lift assembly, the extendable member coupled to the coupler, and a lift actuator engaged with the extendable member to move the extendable member and the coupler in a vertical direction, and where the lift assembly is movably engaged with an overhead rail, and moving the lift assembly along the overhead rail with a transverse actuator toward the detected position of the at least one of the coupler and the extendable member in at least one of a lateral direction and longitudinal direction that is transverse to the vertical direction.

In a tenth aspect A10, the present disclosure provides a method according to aspect A9, further including receiving a user input indicative of a desired direction of operation of the lift actuator upward or downward in the vertical direction, and in response to receiving the user input, moving the extendable member in the desired direction of operation with the lift actuator.

In an eleventh aspect A11, the present disclosure provides a method according to either aspect A9 or A10, where detecting the position of the at least one of the coupler and the extendable member includes detecting the position of the at least one of the coupler and the extendable member with respect to a centered position, and where the method further includes moving the lift assembly at a speed that is proportional to a distance between the detected position of the at least one of the coupler and the extendable member with respect to the centered position.

In a twelfth aspect A12, the present disclosure provides a method according to any of aspects A9-A11, where moving the lift assembly along the overhead rail includes moving the lift assembly along a first overhead rail in a first direction with a first transverse actuator engaged with the first overhead rail, and where the method further includes moving the first overhead rail along a second overhead rail in a second direction with a second transverse actuator engaged with the second overhead rail and the first overhead rail.

In a thirteenth aspect A13, the present disclosure provides a method according to A12, where moving the lift assembly along the second overhead rail is in response to detecting a position of the at least one of the coupler and the extendable member of the lift assembly in the second direction with respect to a centered position.

In a fourteenth aspect A14, the present disclosure provides a method according to any of aspects A9-A13, further including detecting that the at least one of the coupler and the extendable member are positioned at a centered position, and in response to detecting that the at least one of the coupler and the extendable member are positioned at the centered position, ceasing movement of the lift assembly in the lateral direction and the longitudinal direction.

In a fifteenth aspect A15, an overhead subject lift includes a lift assembly configured to be movably engaged with an overhead rail, the lift assembly including a coupler for coupling a subject to the lift assembly, an extendable member coupled to the coupler, an actuator for moving the coupler and the extendable member, and a sensor that detects a position of at least one of the extendable member and the coupler in at least one of a lateral direction and a longitudinal direction.

In a sixteenth aspect A16, the present disclosure provides an overhead subject lift according to aspect A15, where the actuator is a lift actuator that moves the extendable member in a vertical direction with respect to the lift actuator.

In a seventeenth aspect A17, the present application provides an overhead subject lift according to either aspect A15 or A16, where the actuator is a transverse actuator that moves the lift assembly along the overhead rail.

In an eighteenth aspect A18, the present disclosure provides an overhead subject lift according to aspect A17, where the transverse actuator is a first transverse actuator that moves the lift assembly in a first direction, and the overhead subject lift further includes a second transverse actuator that moves the lift assembly in a second direction that is transverse to the first direction along a second overhead rail.

In a nineteenth aspect A19, the present disclosure provides an overhead subject lift according to any of aspects A15-A18, where the sensor defines a sensing region that extends around the extendable member and the coupler.

In a twentieth aspect A20, the present disclosure provides an overhead subject lift according to any of aspects A15-A19, further including a user input communicatively coupled to the actuator. Additional features of the overhead subject lifts and methods for operating the overhead subject lifts described herein will be set forth in the detailed description which follows, and in part will be readily apparent to those skilled in the art from that description or recognized by practicing the embodiments described herein, including the detailed description, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a perspective view of an overhead subject lift, according to one or more embodiments shown and described herein;

FIG. 2 schematically depicts a top view of the overhead subject lift of FIG. 1, according to one or more embodiments shown and described herein; and

FIG. 3 schematically depicts a control diagram of the overhead subject lift of FIG. 1, according to one or more embodiments shown and described herein.

### DETAILED DESCRIPTION

Overhead subject lifts described herein generally include a lift assembly including an extendable member that is coupled to a lift actuator that moves the extendable member upward and downward in the vertical direction. In embodiments, a coupler is coupled to the extendable member, and a subject can be selectively coupled to the coupler, such as through a sling and a sling bar. By moving the extendable member and the coupler in the vertical direction, the lift assembly moves a subject selectively coupled to the coupler in the vertical direction. By moving the subject in the vertical direction, the lift assembly may assist in moving a subject, for example, into and out of a bed, a chair, or the like.

In embodiments, the lift assembly is movably coupled to one or more rails that are mounted to an overhead structure, such as a ceiling or the like. By moving the lift assembly along the overhead rails, subjects coupled to the lift assembly can be moved between different locations, for example between locations within a care facility. In embodiments described herein, overhead lifts generally include one or more transverse actuators, such as motors or the like, that move the lift assembly along the overhead rails.

Lift assemblies, according to embodiments described herein, include a transverse sensor that detects a position of the extendable member and/or the coupler with respect to a centered position. In response to detecting that the extendable member and/or the coupler are positioned away from the centered position, the one or more transverse actuators are directed to move the lift assembly to the detected position of the extendable member and/or the coupler along the overhead rails. For example, in operation, a subject may be suspended from the lift assembly in the vertical direction by the extendable member and the coupler. A user, such as a caregiver, can push or pull the subject with respect to the centered position, thereby moving the extendable member and the coupler with respect to the centered position. By moving the extendable member and/or the coupler with respect to the centered position, the user may direct the movement of the lift assembly along the overhead rails. By allowing the user to direct movement of the lift assembly by pushing or pulling the subject, lift assemblies according to the present disclosure allow the user to move a subject along the overhead rails without requiring the user to interact with a user interface or controller. In this way, lift assemblies of the present disclosure allow a user to move a subject along the overhead rails while allowing the user to maintain one or both hands on the subject to stabilize the subject.

Reference will now be made in detail to embodiments of overhead subject lifts and methods of operating the same, examples of which are illustrated in the accompanying drawings. Whenever possible, the same reference numerals will be used throughout the drawings to refer to the same or like parts.

As used herein, the term “longitudinal direction” refers to the forward-rearward direction of the subject lift (i.e., in the +/−X-direction as depicted). The term “lateral direction” refers to the cross-direction of the subject lift (i.e., in the +/−Y-direction as depicted), and is transverse to the longitudinal direction. The term “vertical direction” refers to the upward-downward direction of the subject lift (i.e., in the +/−Z-direction as depicted), and is transverse to the lateral and the longitudinal directions.

As used herein, the term “communicatively coupled” refers to a relationship between components of the subject lift such that signals (e.g., electronic signals) can be sent between the components. Components of the subject lift may be communicatively coupled through a wired connection or a wireless connection.

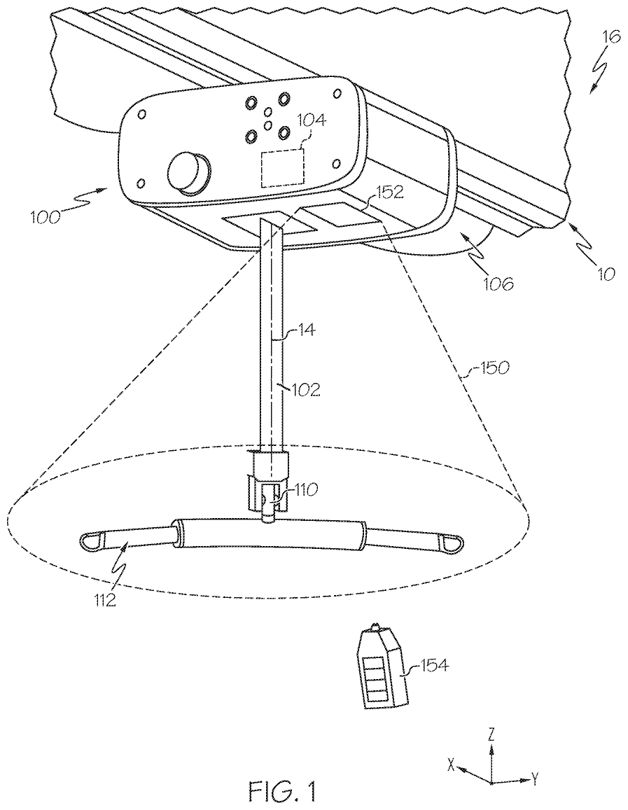

Referring initially to FIG. 1, a perspective view of an overhead subject lift 16 is schematically depicted. The overhead subject lift 16 generally includes a lift assembly 100 that is engaged with an overhead rail 10. The overhead rail 10 may be mounted to a ceiling of a building or the like, such that the lift assembly 100 is generally positioned overhead in the vertical direction.

In embodiments, the lift assembly 100 generally includes a coupler 110, an extendable member 102, and a lift actuator 104. The coupler 110 couples a subject to the lift assembly, and can be selectively coupled to one or more devices engaged with a subject. For example, in the embodiment depicted in FIG. 1, the coupler 110 is selectively coupled to a sling bar 112. In embodiments, the coupler 110 may include a fastener, such as a hook, a clip, or the like, that is selectively coupled to the sling bar 112. Subjects can be selectively coupled to the lift assembly 100 through the sling bar 112 and subject support devices, such as slings, vests, or the like, that are selectively coupled to the sling bar 112.

The extendable member 102 is coupled to the coupler 110, and the lift actuator 104 is engaged with the extendable member 102. In embodiments, the lift actuator 104 moves the extendable member 102 and the coupler 110 upward and downward from the lift actuator 104 in the vertical direction. For example, in some embodiments, the extendable member 102 may include a strap, a chain, or the like, that is wound around a drum coupled to the lift actuator 104. The lift actuator 104 may rotate the drum to pay out the extendable member 102, thereby lowering the coupler 110 in the vertical direction, or rotate the drum to wind up the extendable member 102, thereby raising the coupler 110 in the vertical direction. In embodiments, the lift actuator 104 includes any suitable actuator to move the extendable member 102 and the coupler 110 in the vertical direction, for example and without limitation, a direct current (DC) motor, an alternating current (AC) motor, a pneumatic actuator, a hydraulic actuator, or the like. In some embodiments, the lift actuator 104 is communicatively coupled to a user input 154. The user input 154 is configured to receive an input from a user, such as a caregiver or the like, to actuate the lift actuator 104. For example, a user may provide an input to the user input 154 to direct the lift actuator 104 to raise or lower the extendable member 102 in the vertical direction.

In the embodiment depicted in FIG. 1, the lift assembly 100 further includes a transverse actuator 106 engaged with the overhead rail 10. The transverse actuator 106 generally moves the lift assembly 100 along the overhead rail 10, as described in greater detail herein. In embodiments, the transverse actuator 106 may include, for example and without limitation, a direct current (DC) motor, an alternating current (AC) motor, a pneumatic actuator, a hydraulic actuator, or the like engaged with the overhead rail 10.

In embodiments, the lift assembly 100 further includes a transverse sensor 152 that detects a position of at least one of the extendable member 102 and the coupler 110. For example, in embodiments, the transverse sensor 152 detects a position of the extendable member 102 and/or the coupler 110 with respect to the transverse sensor 152 in the lateral and/or the longitudinal directions. In some embodiments, the transverse sensor 152 detects a position of the extendable member 102 and/or the coupler 110 with respect to a centered position 14. The centered position 14 may generally be the position of the extendable member 102 and the coupler 110 evaluated in the lateral direction and the longitudinal direction when the extendable member 102 and the coupler 110 are at rest (e.g., when the extendable member 102 and the coupler 110 are not subject to any forces in the lateral direction and/or the longitudinal direction). It should be understood that, as referred to herein, the centered position 14 may include a range of positions extending around the position of the extendable member 102 and/or the coupler 110 at rest. For example, in some embodiments, the centered position 14 may include a range extending at least 50 millimeters radially around the position of the extendable member 102 and the coupler 110 at rest. In some embodiments, the centered position 14 may include a range extending at least 200 millimeters radially around the position of the extendable member 102 and the coupler 110 at rest.

In embodiments, the transverse sensor 152 may include any suitable sensor configured to detect the position of the extendable member 102 and/or the coupler 110, for example and without limitation, a radio detection and ranging (RADAR) sensor, a light detection and ranging (LIDAR) sensor, a laser sensor, a camera, a bump sensor, a limit switch, or the like. While in the embodiment depicted in FIG. 1, the lift assembly 100 includes a single transverse sensor 152, it should be understood that the lift assembly 100 may include any suitable number of transverse sensors to detect the position of the extendable member 102 and/or the coupler 110 in the lateral and the longitudinal directions.

In embodiments, the transverse sensor 152 generally defines a sensing region 150 that extends around the extendable member 102 and the coupler 110 in the lateral direction and the longitudinal direction. The sensing region 150 includes a sensing range in which the transverse sensor 152 can detect the position of the extendable member 102 and/or the coupler 110 in the lateral direction and the longitudinal direction with respect to the centered position 14. For example, in embodiments in which the transverse sensor 152 includes an electronic sensor (e.g., a RADAR sensor, LIDAR sensor, laser sensor, camera, etc.), the sensing region 150 may be defined by the range of the transverse sensor 152, and may define a cylindrical or conical region extending around the extendable member 102. In embodiments in which the transverse sensor 152 includes a physical detection sensor (e.g., a limit switch, etc.), the sensing region 150 may be defined by a region in which the extendable member 102 and/or the coupler 110 physically contacts the transverse sensor 152.

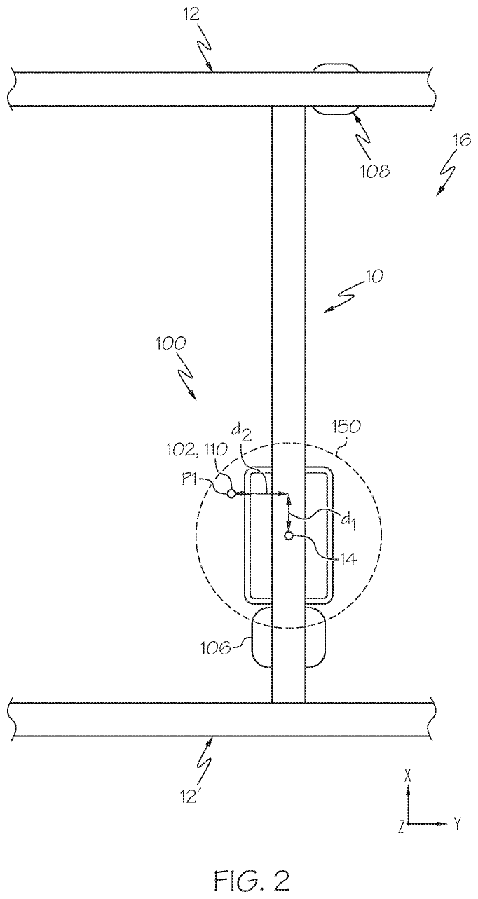

Referring to FIG. 2, a top view of the overhead subject lift 16 is schematically depicted. In some embodiments, the overhead rail 10 is a first overhead rail 10, and the overhead subject lift 16 further includes a second overhead rail 12. In the embodiment depicted in FIG. 2, the first overhead rail 10 generally extends in the longitudinal direction, and the second overhead rail 12 extends in the lateral direction. As depicted in FIG. 2, in some embodiments, the overhead subject lift 16 includes a pair of second overhead rails 12, 12′ extending in the lateral direction with the first overhead rail 10 extending between the pair of second overhead rails 12, 12′ in the longitudinal direction. While in the embodiment depicted in FIG. 2, the overhead subject lift 16 includes the first overhead rail 10 and the pair of second overhead rails 12, 12′, it should be understood that the overhead subject lift 16 may include any suitable number of overhead rails positioned in any suitable orientation to allow the lift assembly 100 to move in the lateral and longitudinal directions.

In the embodiment depicted in FIG. 2, the first overhead rail 10 is engaged with the pair of second overhead rails 12, 12′ and is movable in the lateral direction along the pair of second overhead rails 12, 12′. In embodiments, the overhead subject lift 16 includes a second transverse actuator 108 engaged with one of the pair of second overhead rails 12, 12′ and the first overhead rail 10. In embodiments, the second transverse actuator 108 moves the first overhead rail 10 with respect to the pair of second overhead rails 12, 12′ in the lateral direction. The second transverse actuator 108 may include any suitable actuator, for example and without limitation, a direct current (DC) motor, an alternating current (AC) motor, a pneumatic actuator, a hydraulic actuator, or the like engaged with the first overhead rail 10 and one of the pair of second overhead rails 12, 12′. While in the embodiment depicted in FIG. 2 the overhead subject lift 16 includes a second transverse actuator 108 engaged with the second overhead rail 12 and the first overhead rail 10, it should be understood that the overhead subject lift 16 may include any suitable number of second transverse actuators engaged with either of the pair of second overhead rails 12, 12′, and can include one or more second transverse actuators engaged with the second overhead rail 12 and one or more second overhead actuators engaged with the second overhead rail 12′.

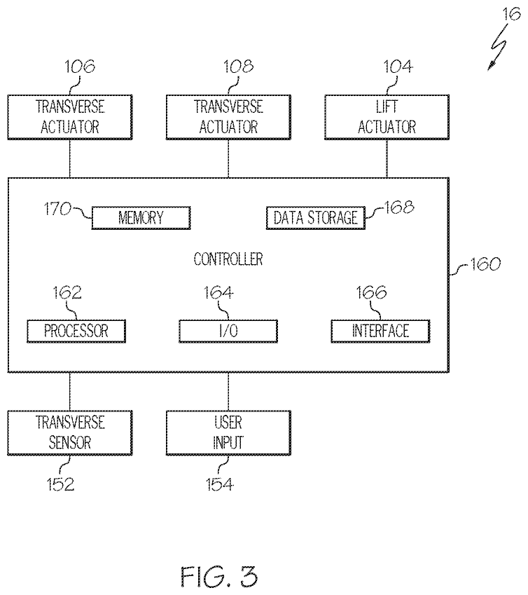

Referring to FIG. 3, a control diagram for the overhead subject lift 16 is schematically depicted according to embodiments described herein. The overhead subject lift 16 generally includes a controller 160. As illustrated, the controller 160 includes a processor 162, input/output hardware 164, a network interface hardware 166, a data storage component 168, and a memory component 170. The memory component 170 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the controller 160 and/or external to the controller 160.

The memory component 170 may store operating logic, analysis logic, and communication logic in the form of one or more computer readable and executable instruction sets. The analysis logic and the communication logic may each include a plurality of different pieces of logic, each of which may be embodied as a computer program, firmware, and/or hardware, as an example. A local interface is also included in the controller 160, and may be implemented as a bus or other communication interface to facilitate communication among the components of the controller 160.

The processor 162 may include any processing component operable to receive and execute instructions (such as from a data storage component 168 and/or the memory component 170). The input/output hardware 164 may include and/or be configured to interface with microphones, speakers, a display, and/or other hardware.

The network interface hardware 166 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the controller 160 and other computing devices.

It should be understood that while the components in FIG. 3 are illustrated as residing within the controller 160, this is merely an example. In some embodiments, one or more of the components may reside external to the controller 160. It should also be understood that, while the controller 160 is illustrated as a single device, this is also merely an example.

In embodiments, the controller 160 is communicatively coupled to one or more components of the overhead subject lift 16. For example, in the embodiment depicted in FIG. 3, the controller 160 is communicatively coupled to the first transverse actuator 106, the second transverse actuator 108, the lift actuator 104, the transverse sensor 152, and the user input 154.

As noted above, in embodiments, the lift actuator 104 may be actuated in response to the receipt of a signal from the user input 154. In particular, a user may provide an input to the user input 154, and the user input 154 may provide a signal to the controller 160 indicative of a desired direction of operation of the lift actuator 104 (e.g., to move the extendable member 102 (FIG. 1) upward or downward in the vertical direction). The processor 162 receives the signal from the user input 154 indicative of the desired direction of operation of the lift actuator 104 upward or downward in the vertical direction, and the processor 162 of the controller 160 may the direct the lift actuator 104 to move the extendable member 102 (FIG. 1) upward or downward in the vertical direction.

Referring collectively to FIGS. 1-3, in embodiments, the first and second transverse actuators 106, 108 are configured to move the lift assembly 100 in the lateral and longitudinal directions along the first overhead rail 10 and the pair of second overhead rails 12, 12′ in response to a detected position of the coupler 110 and/or the extendable member 102.

For example, at rest, the coupler 110 and the extendable member 102 generally extend in the vertical direction along the centered position 14, as depicted in FIG. 1. To move the lift assembly 100 in the lateral and/or the longitudinal directions, a user may move the extendable member 102 and/or the coupler 110 with respect to the centered position 14. For example, a user may push or pull a subject coupled to the extendable member 102 through the sling bar 112 and the coupler 110, thereby moving the extendable member 102 and/or the coupler 110 in the lateral and/or longitudinal directions with respect to the centered position 14.

Referring particularly to FIGS. 1 and 2 by way of example, a user, such as a caregiver or the like, pushes or pulls the subject and, accordingly, the coupler 110 and the extendable member 102 in the lateral and the longitudinal directions with respect to the centered position 14. In the example depicted in FIG. 2, the coupler 110 and the extendable member 102 are positioned at P1, which is spaced apart from the centered position 14 in both the lateral and the longitudinal directions. In particular, P1 is offset from the centered position 14 in the longitudinal direction (i.e., in the X-direction as depicted) by a first distance d1. P1 is also offset from the centered position 14 in the lateral direction (i.e., in the −Y-direction as depicted) by a second distance d2.

In embodiments, the processor 162 (FIG. 3) receives a signal from the transverse sensor 152 indicative of the detected position P1 of the coupler 110 and/or the extendable member 102 with respect to the centered position 14 in the lateral and the longitudinal direction. The processor 162 (FIG. 3), then directs the first transverse actuator 106 and/or the second transverse actuator 108 to move the lift assembly 100 toward the detected position P1. More particularly, in the example depicted in FIG. 2, the first transverse actuator 106 moves the lift assembly 100 along the first overhead rail 10 in the longitudinal direction (e.g., in the +X-direction as depicted) toward the detected position P1. The second transverse actuator 108 moves the first overhead rail 10 along the pair of second overhead rails 12, 12′ in the lateral direction (e.g., in the −Y-direction as depicted) toward the detected position P1. By moving the first overhead rail 10 along the second pair of overhead rails 12, 12′, the second transverse actuator 108 moves the lift assembly 100 in the lateral direction (e.g., in the −Y-direction as depicted) toward the detected position P1.

In some embodiments, the processor 162 directs the first transverse actuator 106 and/or the second transverse actuator 108 to move the lift assembly 100 to the detected position P1 at a speed that is proportional to a distance between the detected position P1 of the extendable member and/or the coupler 110 and the centered position 14. For example, as the distance between P1 and the centered position 14 increases (as evaluated in the lateral and the longitudinal directions), the speed at which the first transverse actuator 106 and/or the second transverse actuator 108 move the lift assembly 100 along the first and second overhead rails 10, 12, 12′ increases. As an example, as the distance between P1 and the centered position 14 increases in the longitudinal direction (e.g., in the X-direction as depicted), the speed at which the processor 162 directs the first transverse actuator 106 to move the lift assembly 100 along the first overhead rail 10 increases. Similarly, as the distance between P1 and the centered position 14 increases in the lateral direction (e.g., in the Y-direction as depicted), the speed at which the processor 162 directs the second transverse actuator 108 to move the first overhead rail 10 along the pair of second overhead rails 12, 12′ increases.

By contrast, as the distance between P1 and the centered position 14 decreases (as evaluated in the lateral and the longitudinal directions), the speed at which the first transverse actuator 106 and/or the second transverse actuator 108 move the lift assembly 100 along the first and second overhead rails 10, 12, 12′ decreases. As an example, as the distance between P1 and the centered position 14 decreases in the longitudinal direction (e.g., in the X-direction as depicted), the speed at which the processor 162 directs the first transverse actuator 106 to move the lift assembly 100 along the first overhead rail 10 decreases. Similarly, as the distance between P1 and the centered position 14 decreases in the lateral direction (e.g., in the Y-direction as depicted), the speed at which the processor 162 directs the second transverse actuator 108 to move the first overhead rail 10 along the pair of second overhead rails 12, 12′ decreases.

Additionally, as the first transverse actuator 106 and/or the second transverse actuator 108 move the lift assembly 100 to the detected position P1, the distance between P1 and the centered position 14 will decrease, absent a user applying force to the extendable member 102 and/or the coupler 110 in the lateral or longitudinal directions. As the distance between P1 and the centered position 14 decreases, the speed at which the first transverse actuator 106 and/or the second transverse actuator 108 move the lift assembly 100 toward P1 decreases. In this way, a user may controllably direct movement of the lift assembly 100 by applying (or not applying) force to the extendable member 102 and/or the coupler 110. Additionally, absent a user applying force to the extendable member 102 and/or the coupler 110 in the lateral or longitudinal directions, the extendable member 102 and/or the coupler 110 will generally extend in the vertical direction at the centered position 14. Upon detecting that the extendable member 102 and/or the coupler 110 are at the centered position 14 via the transverse sensor 152, the processor 162 may direct the first transverse actuator 106 and/or the second transverse actuator 108 to cease moving the lift assembly 100. In this way, the first transverse actuator 106 and the second transverse actuator 108 generally only move the lift assembly 100 in the lateral and the longitudinal directions when external force is applied to the extendable member 102 and the coupler 110, such that unintended operation of the first transverse actuator 106 and the second transverse actuator 108 can be minimized.

Accordingly, it should now be understood lift assemblies, according to embodiments described herein, include a transverse sensor that detects a position of the extendable member and/or the coupler with respect to a centered position. In response to detecting that the extendable member and/or the coupler are positioned outside the centered position, the one or more transverse actuators are directed to move the lift assembly to the detected position of the extendable member and/or the coupler along the overhead rails. For example, in operation, a subject may be suspended in the vertical direction by the extendable member and the coupler. A user, such as a caregiver, can push or pull the subject with respect to the centered position, thereby moving the extendable member and the coupler with respect to the centered position. By moving the extendable member and/or the coupler with respect to the centered position, the user may direct the movement of the lift assembly along the overhead rails. By allowing the user to direct movement of the lift assembly by pushing or pulling the subject, lift assemblies according to the present disclosure allow the user to move a subject along the overhead rails without requiring the user to interact with a user interface or controller. In this way, lift assemblies of the present disclosure allow a user to move a subject along the overhead rails while allowing the user to maintain one or both hands on the subject to stabilize the subject.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An overhead subject lift comprising:
an overhead rail extending at one of a longitudinal direction and a lateral direction;
a lift assembly movably coupled to the overhead rail, the lift assembly comprising:
a coupler for coupling a subject to the lift assembly;
an extendable member coupled to the coupler;
a lift actuator engaged with the extendable member, wherein the lift actuator moves the extendable member and the coupler upward to, and downward from the lift actuator in a vertical direction that is transverse to the longitudinal direction and the lateral direction;
a transverse actuator engaged with the overhead rail; and
a transverse sensor that detects a position of at least one of the extendable member and the coupler; and
a controller communicatively coupled to the lift actuator, the transverse actuator, and the transverse sensor, the controller comprising a processor and a computer readable and executable instruction set, which, when executed, causes the processor to:
receive a signal from the transverse sensor indicative of a detected position of at least one of the coupler and the extendable member in at least one of the longitudinal direction and the lateral direction; and
direct the transverse actuator to move the lift assembly along the overhead rail toward the detected position of the at least one of the coupler and the extendable member.

2. The overhead subject lift of claim 1, further comprising a user input communicatively coupled to the controller, wherein the computer readable and executable instruction set, when executed, further causes the processor to:
receive a signal from the user input indicative of a desired direction of operation of the lift actuator upward or downward in the vertical direction; and
direct the lift actuator to move the extendable member in the desired direction of operation.

3. The overhead subject lift of claim 1, wherein the signal from the transverse sensor is indicative of the detected position of the at least one of the coupler and the extendable member with respect to a centered position, and wherein the computer readable and executable instruction set, when executed, causes the processor to direct the transverse actuator to move the lift assembly at a speed that is proportional to a distance between the detected position of the at least one of the coupler and the extendable member with respect to the centered position.

4. The overhead subject lift of claim 1, wherein the overhead rail is a first overhead rail extending the longitudinal direction and wherein the overhead subject lift further comprises a second overhead rail engaged with the first overhead rail extending in the lateral direction.

5. The overhead subject lift of claim 4, wherein the transverse actuator is a first transverse actuator, and the overhead subject lift further comprises a second transverse actuator engaged with the second overhead rail and the first overhead rail.

6. The overhead subject lift of claim 5, wherein the computer readable and executable instruction set, when executed, further causes the second transverse actuator to move the first overhead rail toward the detected position of the at least one of the coupler and the extendable member.

7. The overhead subject lift of claim 5, wherein the signal from the transverse sensor is indicative of the detected position of the at least one of the coupler and the extendable member with respect to a centered position, and wherein the computer readable and executable instruction set, when executed, further causes the processor to:
direct the first transverse actuator to move the lift assembly along the first overhead rail at a speed that is proportional to a distance between the detected position of the at least one of the coupler and the extendable member with respect to the centered position; and
direct the second transverse actuator to move the first overhead rail at a speed that is proportional to the distance between the detected position of the at least one of the coupler and the extendable member with respect to the centered position.

8. The overhead subject lift of claim 1, wherein the signal from the transverse sensor is indicative of the detected position of the at least one of the coupler and the extendable member with respect to a centered position, and wherein the computer readable and executable instruction set, when executed, further causes the processor to:
receive a signal from the transverse sensor indicating that the detected position of the at least one of the coupler and the extendable member is at the centered position; and
direct the transverse actuator to cease moving the lift assembly.

9. A method for operating an overhead subject lift, the method comprising:
detecting a position of at least one of a coupler and an extendable member of a lift assembly with a transverse sensor, wherein the lift assembly comprises the coupler for coupling a subject to the lift assembly, the extendable member coupled to the coupler, and a lift actuator engaged with the extendable member to move the extendable member and the coupler in a vertical direction, and wherein the lift assembly is movably engaged with an overhead rail; and
moving the lift assembly along the overhead rail with a transverse actuator toward the detected position of the at least one of the coupler and the extendable member in at least one of a lateral direction and longitudinal direction that is transverse to the vertical direction.

10. The method of claim 9, further comprising:
receiving a user input indicative of a desired direction of operation of the lift actuator upward or downward in the vertical direction; and
in response to receiving the user input, moving the extendable member in the desired direction of operation with the lift actuator.

11. The method of claim 9, wherein detecting the position of the at least one of the coupler and the extendable member comprises detecting the position of the at least one of the coupler and the extendable member with respect to a centered position, and wherein the method further comprises moving the lift assembly at a speed that is proportional to a distance between the detected position of the at least one of the coupler and the extendable member with respect to the centered position.

12. The method of claim 9, wherein moving the lift assembly along the overhead rail comprises moving the lift assembly along a first overhead rail in a first direction with a first transverse actuator engaged with the first overhead rail, and wherein the method further comprises moving the first overhead rail along a second overhead rail in a second direction with a second transverse actuator engaged with the second overhead rail and the first overhead rail.

13. The method of claim 12, wherein moving the lift assembly along the second overhead rail is in response to detecting a position of the at least one of the coupler and the extendable member of the lift assembly in the second direction with respect to a centered position.

14. The method of claim 9, further comprising:
detecting that the at least one of the coupler and the extendable member are positioned at a centered position; and
in response to detecting that the at least one of the coupler and the extendable member are positioned at the centered position, ceasing movement of the lift assembly in the lateral direction and the longitudinal direction.

15. An overhead subject lift comprising:
a lift assembly configured to be movably engaged with an overhead rail, the lift assembly comprising:
a coupler for coupling a subject to the lift assembly;
an extendable member coupled to the coupler;
an actuator for moving the coupler and the extendable member; and
a sensor that detects a position of at least one of the extendable member and the coupler in at least one of a lateral direction and a longitudinal direction.

16. The overhead subject lift of claim 15, wherein the actuator is a lift actuator that moves the extendable member in a vertical direction with respect to the lift actuator.

17. The overhead subject lift of claim 15, wherein the actuator is a transverse actuator that moves the lift assembly along the overhead rail.

18. The overhead subject lift of claim 17, wherein:
the transverse actuator is a first transverse actuator that moves the lift assembly in a first direction; and
the overhead subject lift further comprises a second transverse actuator that moves the lift assembly in a second direction that is transverse to the first direction along a second overhead rail.

19. The overhead subject lift of claim 15, wherein the sensor defines a sensing region that extends around the extendable member and the coupler.

20. The overhead subject lift of claim 15, further comprising a user input communicatively coupled to the actuator.
